(19) United States
(12) Patent Application Publication
(10) Pub. No.: US 2005/0073283 A1
(43) Pub. Date: Apr. 7, 2005

(54) Battery latch

(76) Inventors: Charles W. Friedli, Lawrenceville, GA (US); Due Q. Huynh, Lawrenceville, GA (US); William B. Kiger, Dacula, GA (US); Kevin K. Maggert, Lawrenceville, GA (US)

Correspondence Address: MOTOROLA ENERGY SYSTEMS GROUP, 1700 BELLE MEADE COURT, LAWRENCEVILLE, GA, 30043, US

(21) Appl. No.: 10/677,922

(22) Filed: Oct. 1, 2003

(51) Int. Cl. H02J 7/00

(52) U.S. Cl. 320/114

(57) ABSTRACT

A latch assembly for coupling a rechargeable battery to an electronic device is provided. The latch assembly includes an insertable latch having barbed wing members extending distally from a planar member. The planar member includes several features, including an insertion snap, a spring retention post and a mechanical stop. The latch is inserted into a latch aperture in a battery pack housing. The latch aperture includes a plurality of slots for receiving the various features of the latch. A spring, like a butterfly spring for example, provides an outward force between the latch and the housing. The latch assembly is designed for ease of manufacture, in that assembly is simply inserting the spring in the latch aperture and then snapping in the latch.

### BACKGROUND

1. Technical Field

This invention relates generally to rechargeable battery packs, and more specifically to latching mechanisms for coupling a rechargeable battery pack to a host device.

2. Background Art

Portable electronic devices, such as two-way radios and portable computers, typically require a portable source of power such as a battery. A battery may be conveniently attached to the housing of the electronic device and make electrical contact by way of a conventional connector. To facilitate battery replacement, mechanisms have been devised to enable the user to easily disconnect a spent battery and replace it with a freshly charged battery. Generally, the detachable battery is securely affixed to the electronic device by way of some sort of latching mechanism. Often, the latching mechanism is integrated into the battery housing.

One exemplary application for such detachable batteries is in portable, laptop computers. These computers generally weigh between three and ten pounds. A typical rechargeable battery pack used with a laptop computer includes four to six rechargeable cells, in addition to battery protection and charging circuitry. Such a battery pack may weigh as much as two pounds.

Latching mechanisms for coupling these relatively substantial battery packs to computers must be robust, in that computer manufacturers generally demand that the computer/battery assembly be able to withstand rigorous “drop tests” without separating. For example, some manufacturers may require a computer/battery assembly to survive a drop of four or more feet onto a concrete surface without coming apart. Additionally, laptop computer latches must be able to be coupled to, and detached from, the computer several hundreds of times without failure.

While there are many latch designs, simple nuances here and there in the design can mean significant changes in performance. Referring now to FIG. 1, illustrated therein is one prior art latch for a laptop computer. A push-button style latch 101 is inserted with a two-dimensional motion (down, under and out) into an aperture 102 of a battery housing 100. While a technician holds this with his fingers, a spring 103 must be coupled between a vertical member (not shown) of the housing 100 and the latch 101. While holding this spring loaded assembly, a barbed member 104 is then coupled to the latch 101 by a pair of screws 106. The screws 106 must be inserted into a pair of screw bosses 105 in the barbed member 104 and then tightened into threaded apertures 107 in the latch 101.

Since the screws 106 are metal, they are electrically conductive. To keep them from shorting components inside the battery pack, the screw bosses 105 must be melted such that plastic insulates the screws from the contents of the battery pack.

This prior art latch presents at least two problems. The first is the complex assembly procedure. With so many parts, some of which are spring loaded, this latching mechanism is both difficult and expensive to manufacture on a high volume basis. Only highly-skilled, experienced technicians will be successful in assembling the latching mechanism.

The second problem emanates from the fact that this latch will be subjected to the harsh drop test mentioned above. If there is any failure in the screw bosses 105, the screws 106 may come loose inside the battery pack. Loose screws may short cells and other electronic components, thereby potentially causing hazardous operating conditions.

There is thus a need for an improved latch for rechargeable battery packs.

### BRIEF DESCRIPTION OF THE DRAWINGS

FIG. 1 illustrates a prior art latching assembly.

FIGS. 2 and 3 illustrate one preferred embodiment of a latch in accordance with the invention.

FIG. 4 illustrates a battery pack employing a latch in accordance with the invention.

FIG. 5 illustrates one preferred embodiment of a latch, latch aperture and butterfly spring in accordance with the invention.

FIG. 6 illustrates a latch assembly in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

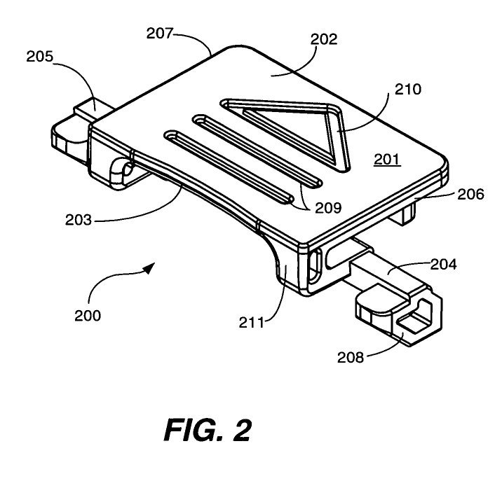

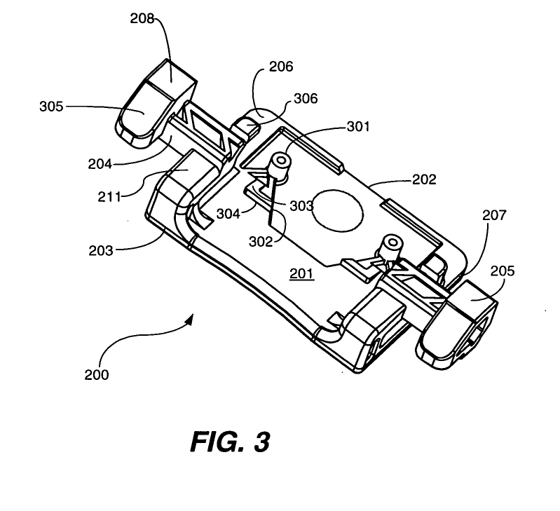

Referring now to FIGS. 2 and 3, illustrated therein is one preferred embodiment of a latch in accordance with the invention. FIG. 2 illustrates a top, front, right, perspective view of the latch, while FIG. 3 illustrates a bottom, front, left perspective view of the same. The figures will be referred to simultaneously until otherwise noted.

The latch 200 includes a planar member 201 that serves as the central mechanical structure. The latch 200 includes at least one spring retention post 301 coupled to the planar member 201. Additionally, the latch 200 includes at least one insertion snap 302 coupled to the planar member 201. The insertion snap 302 is preferably triangular in cross section, with an inclined member 303 disposed towards the rear 202 of the planar member 201, and a vertical member disposed towards the front 202 of the planar member 201.

The latch 200 includes at least one barbed wing member 204 coupled to the planar member 201. The barbed wing member 204 extends distally outward from the planar member 201. In one preferred embodiment, as shown in FIGS. 2 and 3, the latch 200 includes two barbed wing members 204,205. One barbed wing member 204 extends distally outward from one edge 206 of the planar member 201, while the other barbed wing member 205 extends distally outward from the opposite edge 205 of the planar member 201. In this arrangement, the two barbed wing members 204,205 are preferably collinear for structural stability.

The barbed wing member 204 includes a barb 208 that facilitates the latch 200 coupling to an electronic device. The barb 208 preferably extends perpendicularly from the barbed wing member 204. The barb 208 includes an inclined planar member 305 that causes the latch 200 to depress when coupled to an electronic device.

The latch 200 includes at least one barbed wing member support 211. The barbed wing member support 211 extends perpendicularly from the planar member 201 such that the barbed wing member 204 is in a non-coplanar geometric relationship with the planar member.

The latch 200 includes at least one mechanical stop 306 that prevents the latch from being depressed too far into the battery housing. The latch 200 optionally includes a finger grip 209 to ease latch operation, as well as an optional directional guide 201 instructing a user which way to depress the latch to decouple the rechargeable battery pack from the electronic device.

The latch 200 is preferably made by an injection molding process, out of a robust plastic material, like polycarbonate. It will be clear to those of ordinary skill in the art that other materials may be equally substituted. For example, the material may be any of the following: equivalent plastics, styrene, acrylonitrile butadiene styrene (ABS), polystyrene, acrylic, polycarbonate-ABS, resins, and rubber.

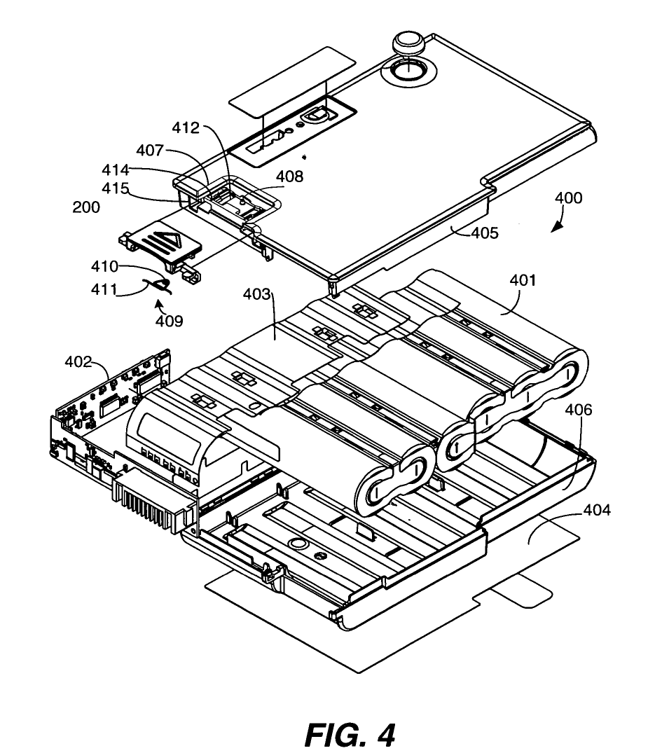

Referring now to FIG. 4, illustrated therein is a rechargeable battery pack 400 including a latch in accordance with the invention. The battery pack includes a housing that is made from two parts, a top 405 and a bottom 406. Rechargeable cells 401 are inserted into the housing. The rechargeable cells 401 provide energy to power an electronic device. The pack 400 optionally includes electronic circuitry, which provides safety protection, fuel gauging, charging functions and the like. The electronic circuitry may be disposed on either a printed circuit board 402 or a flexible substrate 403.

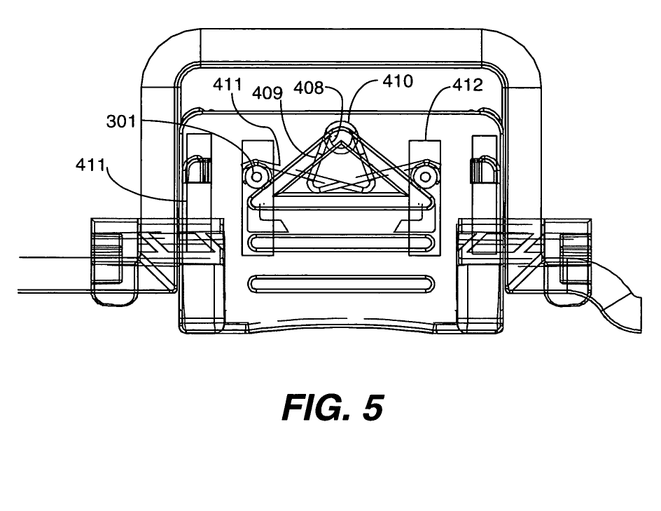

One of the housing parts, for example the top 405, includes a latch aperture 407 for receiving a battery latch 200. The latch aperture 407 includes 408 at least one spring retention post for retaining a spring 409. Testing has shown that a butterfly spring 409 works well in this application, as the loop 410 of the butterfly spring 409 may be disposed about the spring retention post 408 in the latch aperture 407. The arms 411 of the butterfly spring 409 may then be positioned against the spring retention post of the latch (element 301 of FIG. 3). This spring alignment may be seen in FIG. 5.

The latch aperture 407 includes at least one slot 412 for receiving the insertion snap (element 302 of FIG. 3). When the latch 200 is inserted into the latch aperture 407, the inclined planar member of the insertion snap rides over the edge 413 of the housing 405. Once across, the vertical member of the insertion snap keeps the latch 200 securely coupled within the latch aperture 407 by way of the slot 412 for receiving the insertion snap.

The latch aperture 407 further includes at least one slot 414 for receiving the at least one mechanical stop (element 306 of FIG. 3). The slot 414 for receiving the mechanical stop prevents the latch 200 from being depressed too far into the housing 405. The slots 412,414 are more clearly shown in FIG. 5. Referring again to FIG. 4, the latch aperture 407 also includes at least one slot 415 for receiving the at least one barbed wing member (element 204 of FIG. 2).

The latch assembly described herein offers numerous advantages over the prior art. For example the latch, with the insertion snap included, offers more than 350 grams of latch retention spring force. Further, the insertion snaps will withstand over 8 kilograms of outward pull without letting the latch decouple from the latch aperture.

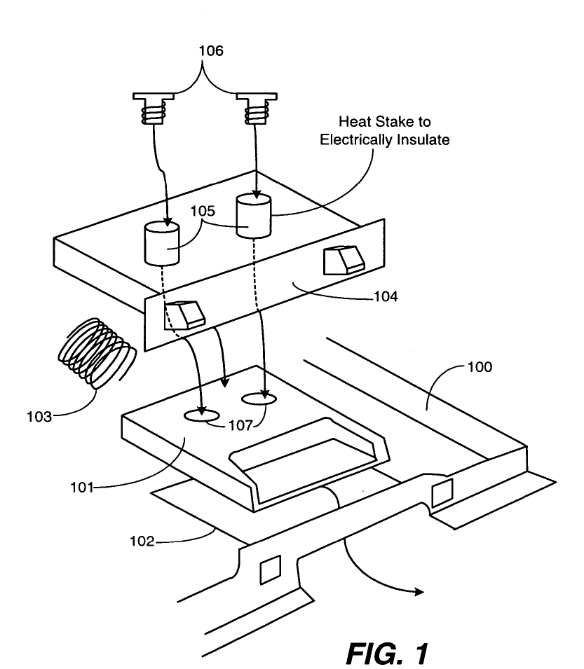

The latch design offers a reduced part count, and corresponding reduced cost, over the prior art. For example, in comparison with the prior art latch of FIG. 1, the latch of the present invention reduces the part count from 7 components to 2, neglecting the pack housing. This resulted in a 50% cost savings in the overall latch assembly.

One of the foremost advantages over the prior art is the elimination of metal screws. Recall from above that failures of the prior art latch in FIG. 1 can result in loose, metal screws rattling about in the battery pack. The latch of the present invention eliminates screws, and thus eliminates the corresponding safety hazards associated with screws.

The latch of the present invention is also much simpler to assemble than the prior art latch. Recall from above that the prior art latch was also very complex to assemble. Assembly required the following steps: Manual insertion of the spring, which was very tedious; Placement of both a barbed member and the latch about the spring (this had to be done without letting the spring fall out or soaring loose); Placing and securing two screws within heat-staked bosses; and Heat staking caps over the tops of the screws to protect the screws against shorting with other components within the battery pack.

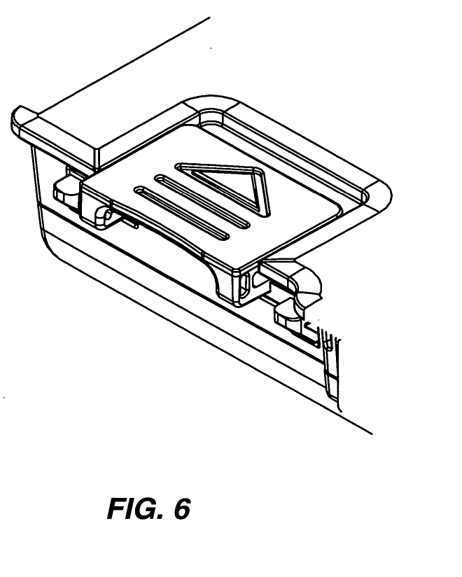

By contrast the latch assembly of the present invention is assembled simply by placing the butterfly spring about the spring retention post in the latch aperture, and then inserting the latch into the latch aperture. The latch simply snaps in upon insertion by way of the insertion snaps. The latch assembly is illustrated in FIG. 6.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while the latch assembly has been described herein as relating to a rechargeable battery pack, it will be obvious to those of ordinary skill in the art that the latch assembly may be equally applied to numerous other devices, including primary batteries, detachable accessories (including disk drives), and the like.

1. A latch for a rechargeable battery pack, comprising:
a. a planar member;
b. at least one spring retention post coupled to the planar member;
c. at least one insertion snap coupled to the planar member; and
d. at least one barbed wing member coupled to the planar member, extending distally outward from the planar member.

2. The latch of claim 1, further comprising at least one mechanical stop coupled to the planar member.

3. The latch of claim 2, further comprising at least one barbed wing member support, wherein the at least one barbed wing member support extends perpendicularly from the planar member such that the barbed wing member is in a non-coplanar geometric relationship with the planar member.

4. The latch of claim 2, further comprising a finger grip on the planar member.

5. The latch of claim 1, wherein the latch comprises two barbed wing members, wherein a first barbed wing member extends distally from a first edge of the planar member, and a second barbed wing member extends distally from a second edge of the planar member, wherein the first barbed wing member and the second barbed wing member are collinear.

6. The latch of claim 3, wherein each of the barbed wing members comprises at least one barb, wherein the at least one barb extends from the barbed wing members perpendicularly.

7. The latch of claim 6, wherein the at least one barb comprises at least one inclined planar member.

8. The latch of claim 7, wherein the latch is manufactured from a material selected from the group consisting of plastics, styrene, ABS, polystyrene, acrylic, polycarbonates, resin, and rubber.

9. A rechargeable battery pack, comprising:
a. at least one rechargeable battery cell;
b. a housing comprising a top and a bottom, into which the at least one rechargeable battery cell is placed, wherein the housing comprises at least one latch aperture for receiving a battery latch; and
c. the latch of claim 1.

10. The battery pack of claim 9, further comprising a butterfly spring.

11. The battery pack of claim 10, wherein the latch aperture comprises at least one spring retention post.

12. The battery pack of claim 9, wherein the latch aperture comprises at least one slot for receiving the at least one insertion snap.

13. The battery pack of claim 9, wherein the latch aperture comprises at least one slot for receiving the at least one mechanical stop.

14. The battery pack of claim 9, wherein the latch aperture comprises at least one slot for receiving the at least one barbed wing member.
